(19) United States
(12) Patent Application Publication
(10) Pub. No.: US 2024/0143246 A1
(43) Pub. Date: May 2, 2024

(54) PRINT INSTRUCTION SYSTEM, PRINTING METHOD, NON-TRANSITORY COMPUTER-READABLE STORAGE MEDIUM STORING PRINT INSTRUCTION PROGRAM

(71) Applicant: SEIKO EPSON CORPORATION, Tokyo (JP)

(72) Inventors: Ayako KOBAYASHI, Okaya (JP); Yuka KOBAYASHI, Shiojiri (JP); Yuko ISHIFURO, Shiojiri (JP); Yuto FUKUCHI, Matsumoto (JP)

(21) Appl. No.: 18/494,795

(22) Filed: Oct. 26, 2023

(30) Foreign Application Priority Data
Oct. 28, 2022 (JP) 2022-173155

(51) Int. Cl. G06F 3/12

(52) U.S. Cl. CPC G06F 3/1208; G06F 3/1242

(57) ABSTRACT

A print instruction system includes an identifying unit that causes a reader to read an actual print sample or an identifier attached to the actual print sample, an acquisition unit that acquires image data, a confirmation unit that displays a print preview when the image data and a feature of the print sample are combined, and a printing unit that performs printing using the image data according to an instruction by a user after displaying the print preview.

The present application is based on, and claims priority from JP Application Serial Number 2022-173155, filed Oct. 28, 2022, the disclosure of which is hereby incorporated by reference herein in its entirety.

### BACKGROUND

### 1. Technical Field

The present disclosure relates to a print instruction system, a print method, and a non-transitory computer-readable storage medium storing a print instruction program.

### 2. Related Art

In the related art, techniques for performing printing on various media other than paper media are known. For example, JP-A-2022-39737 describes printing on the surface of a can. JP-A-2021-187025 describes printing on a medium having a specular reflective layer.

It is conceivable to display a pre-printed print sample so that a user who is unfamiliar with printing on media other than paper can easily visualize the finished image. In such a case, it is desirable that the user can easily perform printing using the print sample.

### SUMMARY

According to an aspect of the present disclosure, a print instruction system includes an identifying unit that causes a reader to read an actual print sample or an identifier attached to the actual print sample to identify a feature of the print sample, an acquisition unit that acquires image data, a confirmation unit that displays a print preview when the image data and a feature of the print sample are combined, and a printing unit that performs printing using the image data according to an instruction by a user after displaying the print preview.

According to another aspect of the present disclosure, a method for producing a printed matter includes reading an actual print sample or an identifier attached to the actual print sample with a reader, acquiring image data, displaying a print preview when the image data and the feature of the print sample corresponding to the identifier are combined, and performing printing using the image data after displaying the print preview to produce a printed matter.

According to still another aspect of the present disclosure, in a non-transitory computer-readable storage medium storing a print instruction program, the program causes a computer to function as an identifying unit that causes a reader to read an actual print sample or an identifier attached to the actual print sample to identify a feature of the print sample, an acquisition unit that acquires image data, a confirmation unit that displays a print preview when the image data and a feature of the print sample are combined, and a printing unit that performs printing using the image data according to an instruction by a user after displaying the print preview.

### BRIEF DESCRIPTION OF THE DRAWINGS

FIG. 1 is a block diagram of a print instruction system.

FIG. 2 is a block diagram showing the configuration of a server.

FIG. 3 is a block diagram showing the configuration of a user terminal.

FIG. 4 is a block diagram showing the configuration of a staff terminal.

FIG. 5 is a block diagram showing the configuration of a printer.

FIG. 6 is a sequence diagram showing generation of a print sample and an identifier.

FIG. 7 is a diagram showing an example of a print medium selection screen.

FIG. 8 is a diagram showing an example of a template selection screen.

FIG. 9 is a diagram showing an example of a photo selection screen.

FIG. 10 is a diagram showing an example of a finish confirmation screen.

FIG. 11 is a diagram showing an example of an actual print sample and an identifier attached to the actual print sample.

FIG. 12 is a sequence diagram showing the sequence of reading the identifier of the print sample and producing the printed matter.

FIG. 13 is a diagram showing a configuration example of the correspondence stored in a storage unit.

### DESCRIPTION OF EMBODIMENTS

Here, embodiments of the present disclosure will be described according to the following order.
1 Configuration of print instruction system
1-1 Server configuration
1-2 Terminal configuration
1-3 Printer configuration
2 Print sample production process
3 Print instruction process
4 Other embodiments

### 1 Configuration of Print Instruction System

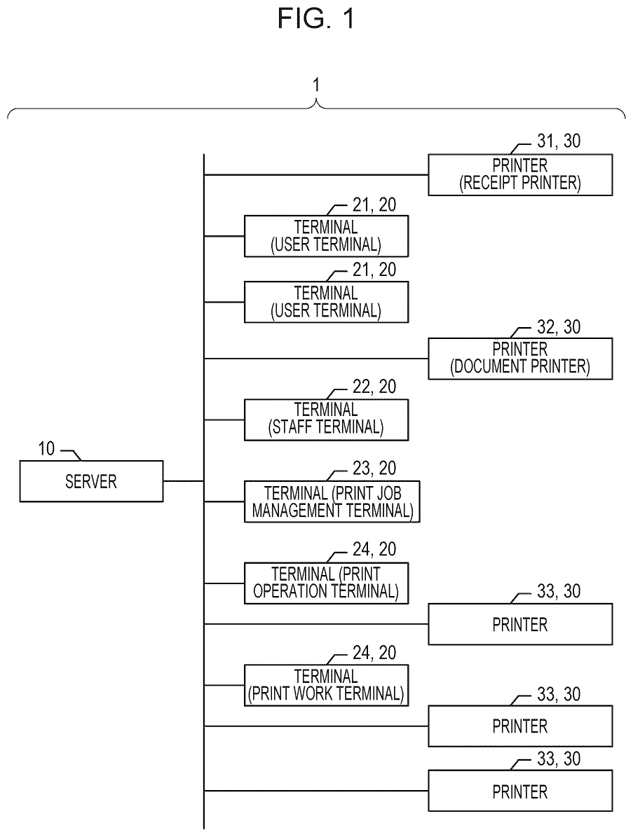

FIG. 1 is a diagram schematically showing an example of a print instruction system according to an embodiment of the disclosure. A print instruction system 1 includes a server 10, a terminal 20 and a printer 30. The number of devices shown is an example, and the number is not limited. For example, the number of a plurality of terminals 20 and the number of a plurality of printers 30 are not limited to the number shown in FIG. 1, and the one servers 10 that is shown may be plural. These devices can communicate with each other over a network. The network may take various forms, including a local network, or devices physically separated from each other may communicate with each other via the Internet or the like.

In the present embodiment, the terminal 20 and the printer 30 are installed in a store such as a photo store or a variety store, for example. The store prints an image designed using a photograph, and the like designated by a user on a print medium (mug, T-shirt, smartphone case, can badge, paper of various sizes and materials, or the like) selected by the user who is a customer of the store to provide a printing service to a produce souvenir and user-original goods.

The terminals 20 include a terminal (a user terminal 21) used by a user who is a customer of the store to design a print image, a terminal (a staff terminal 22) used by a staff member who responds to the user, a terminal for managing a print job (a print job management terminal 23), and a terminal (a print operation terminal 24) in which a printer driver and a print application for each printer are installed and that is used by a print operator.

The printers 30 include a receipt printer 31 that prints the reference number of the provisional order, a document printer 32 that prints an order slip, and a printer 33 that prints the image designed by the user on the print medium selected by the user. The printer 33 includes, for example, a minilab machine suitable for performing printing on photo paper, a sublimation transfer printer capable of performing printing on sublimation transfer paper that is pressure bonded to a mug (pottery), a can badge, or a smartphone case, a large-format printers suitable for performing printing on a large-sized paper medium such as a poster, and the like, and a direct to garment (DTG) printer that can directly perform printing on a fabric product such as a T-shirt, and the like.

The user operates the user terminal 21 and designs an image to be printed on a print medium using a design application installed in the user terminal 21. Specifically, the user selects a print medium using a design application and selects a template according to the print medium. Furthermore, the user designates a photo desired by the user using a design application, and designs an image to be printed on a print medium using a template. The user can, for example, transfer a photo saved in his/her mobile terminal to the user terminal 21 and designate the transferred photo. The user can designate the number of copies and request printing of the image designed by the user on the selected print medium.

While some users can freely design the print image using the design application of the user terminal 21, other users who are not accustomed to such design may have difficulties in selecting the type of print medium and other various options from the scratch. Therefore, it is conceivable for the store to display several print samples (a sample image printed on a sample print medium) in advance. The print instruction system of the present embodiment is configured so that the user can easily create printed matter using desired image data using such a print sample.

The configuration of each device of the print instruction system 1 for implementing such a printing service will be described below.

### 1-1 Server Configuration

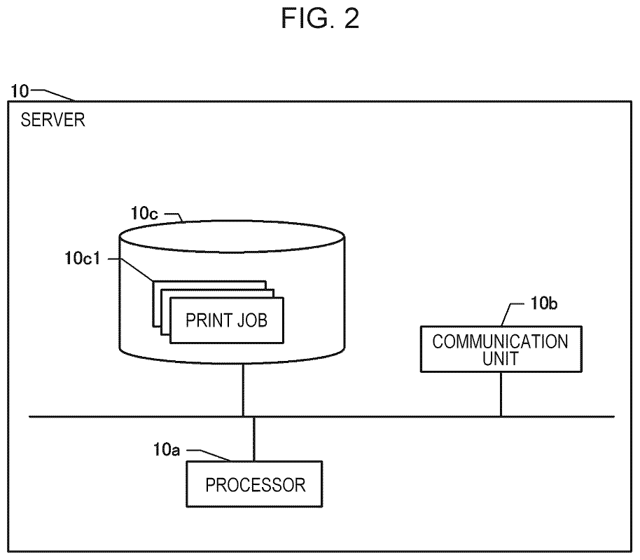

FIG. 2 is a block diagram showing the configuration of the server 10. The server 10 includes a processor 10a, a communication unit 10b, and a nonvolatile memory 10c. The processor 10a can include a CPU, a ROM, a RAM, and the like (not shown), and execute various programs recorded in the nonvolatile memory 10c to control each components of the server 10 and each device connected to the network. Note that the processor 10a may be configured by a single chip, may be configured by a plurality of chips, or may be configured as an SoC together with various functional blocks that operate the printer. Also, for example, an ASIC may be employed instead of the CPU, or a configuration in which the CPU and the ASIC cooperate may be employed. When each device in the present embodiment includes a processor, the processor can be implemented in various manners as in the processor 10a.

The communication unit 10b includes a communication interface for communicating with external equipment according to various communication protocols in a wired or wireless manner. The server 10 can communicate with another device via the communication unit 10b. The communication unit 10b may include an interface for communicating with various removable memories attached to the server 10.

The nonvolatile memory 10c of the server 10 stores various types of information including a print job 10c1. The print job 10c1 includes image data (print image) on which various processes are performed based on the user's design, the type of print medium, the number of copies, and the like. The user designs a print image using a design application installed in the user terminal 21. When a user places a provisional order for a designed print image by designating the number of copies, and the like, a print job including the print image, the type of print medium, the number of copies, and the like is transmitted to the server 10 and recorded in the nonvolatile memory 10c of the server 10. The server 10 causes the user terminal 21 to perform printing. The user receives the receipt from the receipt printer 31 and goes to the reception counter.

Further, the server 10 transmits the provisionally ordered print job 10c1 to the staff terminal 22. At the reception counter, the staff member who manages orders will serve the user. The staff member can operate the staff terminal 22 to check the content of the print job 10c1 while interacting with the user. As a result of the dialogue, the staff member can change or add the number of copies, the color and size of the print medium, and the like, if necessary. After the staff member and the user check the content of the print job 10c1, the staff member can operate the staff terminal 22 to confirm the order for the print job 10c1. Confirmation of a provisional order is also referred to herein as an official order. The confirmed print job 10c1 is transmitted from the staff terminal 22 to the server 10 and recorded in the nonvolatile memory 10c. When the server 10 receives the print job 10c1 of the official order, the server 10 assigns an order number and records the order number in association with the print job 10c1. Although the order number and the reference number are different numbers in the present embodiment, they may be the same in another embodiment. When the server 10 receives the officially ordered print job 10c1, the server 10 transmits the print job 10c1 to the print job management terminal 23 and instructs printing.

### 1-2 Terminal Configuration

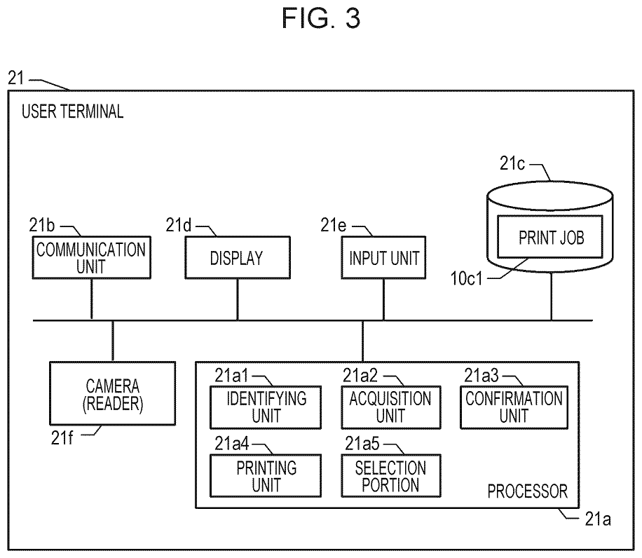

Next, the configuration of the terminal 20 will be described. The hardware configuration of the terminal 20 has common parts between the user terminal 21, the staff terminal 22, the print job management terminal 23, and the print operation terminal 24. FIG. 3 is a block diagram showing the configuration of the user terminal 21. The user terminal 21 includes a processor 21a, a communication unit 21b, a nonvolatile memory 21c, a display 21d, an input unit 21e, and a camera 21f. The processor 21a can include a CPU, a ROM, a RAM, and the like (not shown), and execute various programs recorded in the nonvolatile memory 21c to control each component of the user terminal 21.

The communication unit 21b includes a communication interface for communicating with external equipment according to various communication protocols in a wired or wireless manner. The user terminal 21 can communicate with another device via the communication unit 21b. The communication unit 21b also includes an interface for communicating with various removable memories attached to the user terminal 21.

The display 21d is a display device that displays an any image. The input unit 21e is a device for a user to perform an input operation, and includes, for example, a keyboard, a mouse, a touch panel, and the like. In any case, the user can operate the input unit 21e to input the user's intention while viewing images and characters displayed on the display 21d. The camera 21f photographs a subject, generates an image, and outputs the image. In the present embodiment, the camera 21f functions as a reader that reads the identifier (two-dimensional code) attached to the actual print sample.

A design application is installed in the user terminal 21, and by executing the design application, the processor 21a of the user terminal 21 functions as an identifying unit 21a1 that identifies the feature of the print sample from the identifier read by the camera 21f, an acquisition unit 21a2 that acquires image data, a confirmation unit 21a3 that displays a print preview when the image data and a feature of the print sample are combined, and a printing unit 21a4 that causes the printer 33 to perform printing. The processor 21a also functions as a selection unit 21a5 that causes the user to select at least one print medium from the print medium of the print sample and a plurality of print media different in size from the print medium of the print sample. Details of these units will be described later.

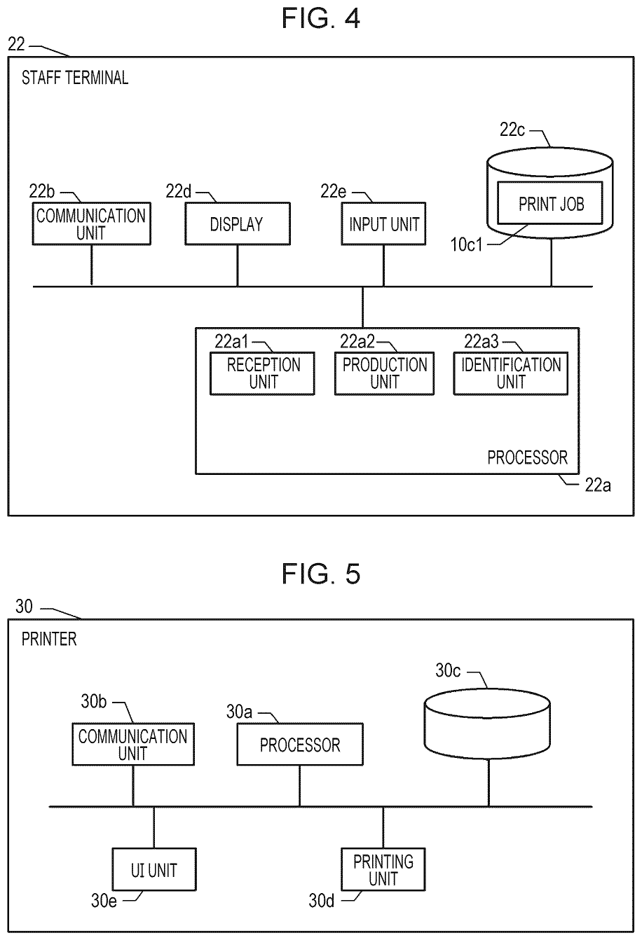

FIG. 4 is a block diagram showing the configuration of the staff terminal 22. Since the hardware configuration is the same as that of the user terminal 21, part of the description will be omitted. The staff terminal 22 may or may not include a camera. By operating the staff terminal 22, the staff member can give instructions such as order confirmation (official order) for the print job 10c1 received from the server 10. After confirming the order, the staff terminal 22 causes the document printer 32 to print an order slip indicating the content of the confirmed order.

In the present embodiment, the staff terminal 22 is also used as a terminal for producing a print sample and an identifier. For this reason, the staff terminal 22 has a design application similar to that of the user terminal 21. The staff member designs the image to be printed on the print sample using the design application of the staff terminal 22 and instructs printing. In this case, a processor 22a of the staff terminal 22 functions as a reception unit 22a1 that receives designation of the print medium and designation of the sample image data, and a production unit 22a2 that produces the actual print sample by performing printing on the received print medium based on the received sample image data.

In the present embodiment, the staff terminal 22 is also used to produce identifiers for identifying the print medium used for print samples. In the present embodiment, a two-dimensional code image is printed on paper as the identifier. A two-dimensional code generation application is installed in the staff terminal 22. The staff member produces a two-dimensional code image for identifying the print medium of the print sample using this two-dimensional code generation application. In this case, the processor 22a of the staff terminal 22 functions as an identification unit 22a3. Details of these will be described later.

The print job management terminal 23 and the print operation terminal 24 (see FIG. 1) have the same hardware configuration as the staff terminal 22. Upon receiving the print instruction from the server 10, the print job management terminal 23 selects the print operation terminal 24 corresponding to the printer 33 executing the print job to transmit the print job to the print operation terminal 24. The selection of the print operation terminal 24 may be made manually by the print operator. A printer driver and a print application for each printer 33 are installed in the print operation terminal 24. A print operator can perform various pre-process operations such as color matching before printing using these programs.

The print operator operates the print operation terminal 24 to select a printer that is to print the print job and select a print setting to be used for printing the print job. Note that these selections may be made by the print job management terminal 23. For example, the processor of the print job management terminal 23 or the print operation terminal 24 presents a list of printers 33 capable of executing the print job, and acquires a printer 33 selected by the print operator. Also, for example, the processor of the print job management terminal 23 or the print operation terminal 24 presents a list of a plurality of print settings related to the execution of the print job, and acquires a print setting selected by the print operator from the list. The print operation terminal 24 converts the image data of the print job into a print format for the designated printer 33 based on the print settings to output the print data generated as a result of the conversion to the printer 33 together with information about the number of copies. When the printing is completed, the print operation terminal 24 notifies the server 10 via the print job management terminal 23 of progress information indicating that the printing is completed.

### 1-3 Printer Configuration

FIG. 5 is a block diagram showing the configuration of the printer 30. The printers 30 include the receipt printer 31, the document printer 32, and the printer 33 that performs printing on the product. The printer 30 includes a processor 30a, a communication unit 30b, a nonvolatile memory 30c, a printing unit 30d, and a UI unit 30e. The processor 30a can include a CPU, a ROM, a RAM, and the like (not shown), and execute various programs recorded in the nonvolatile memory 30c to control each component of the printer 30.

The communication unit 30b includes a communication interface for communicating with external equipment according to various communication protocols in a wired or wireless manner. The printer 30 can communicate with another device via the communication unit 30b. Note that the communication unit 30b may include an interface for communicating with various removable memories attached to the printer 30.

The receipt printer 31, the document printer 32, and the printer 33 include different the printing units 30d. The printing unit 30d is a unit that performs printing, and performs printing on various media including plain paper, photo paper, sublimation transfer paper, cloth, and the like by various printing methods including an ink jet method. For example, the printing unit 30d of the receipt printer 31 performs printing on roll paper having a width selected in advance as a receipt. The printing unit 30d of the document printer 32 performs printing on cut paper such as A4 size paper. The printing unit 30d of the printer 33 performs printing on various three-dimensional or sheet-like print media handled by the store. The printing unit 30d includes an actuator, various devices, a sensor, a drive circuit, a mechanical part, and the like for executing printing on various media. The sensor includes a sensor that detects various detection targets that can change in the printer 30. The detection target is not limited, and examples of the sensor include a sensor that detects the remaining amount of media and a sensor that detects the remaining amount of ink for each color used for printing.

The UI unit 30e includes at least one of a touch panel display, various keys, switches, LEDs, and the like. The touch panel display includes a display panel that displays various types of information, such as the status of the printer 30 and the remaining amount of ink, and a touch detection panel superimposed on the display panel, and detects a touch operation. The LED lights up or flashes to indicate the status of the printer 30 or the like. The processor 30a can acquire content of the operation by the staff member via the UI unit 30e. In addition, the processor 30a can display various pieces of information on the display of the UI unit 30e and notify the staff member of the information.

In the present embodiment, the printer 33 produces printed matter ordered in accordance with an order from the user and a print instruction from the staff member in a store such as a photo store or a variety store. The processor 30a of the printer 33 acquires print data converted into the print format of the printer 33 via the communication unit 30b, controls the printing unit 30d based on the print data, and performs printing. When the printing is completed, the processor 30a outputs progress information indicating that the printing is completed via the communication unit 30b. The information is transmitted to the server 10 via the print operation terminal 24 and the print job management terminal 23. When the server 10 acquires the information via the communication unit 10b, the processor 10a of the server 10 updates the progress information about the print job 10c1 for which printing has been completed to “printing completed”.

### 2 Print Sample Production Process

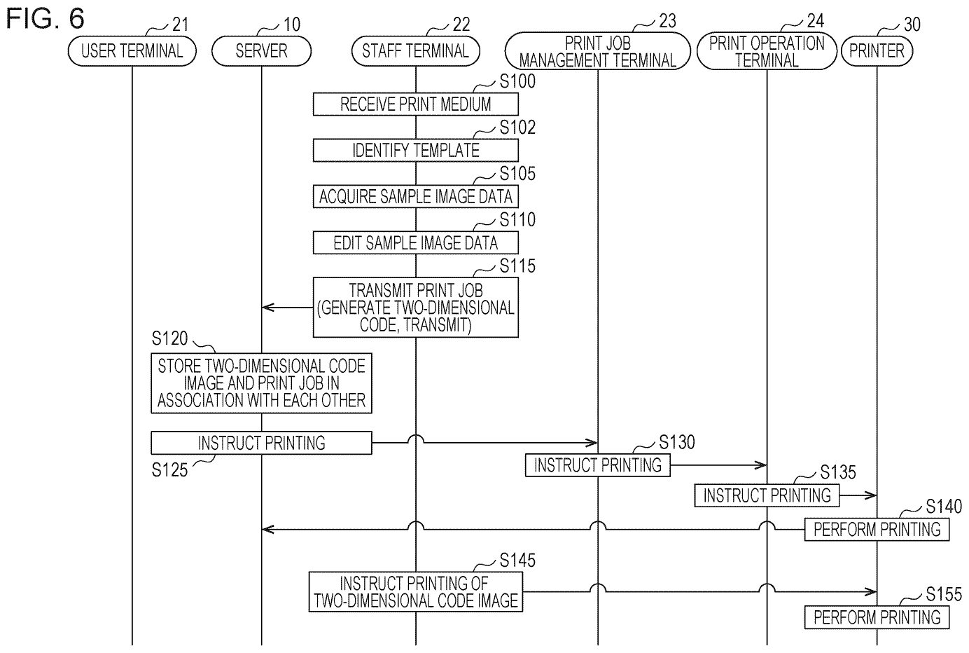

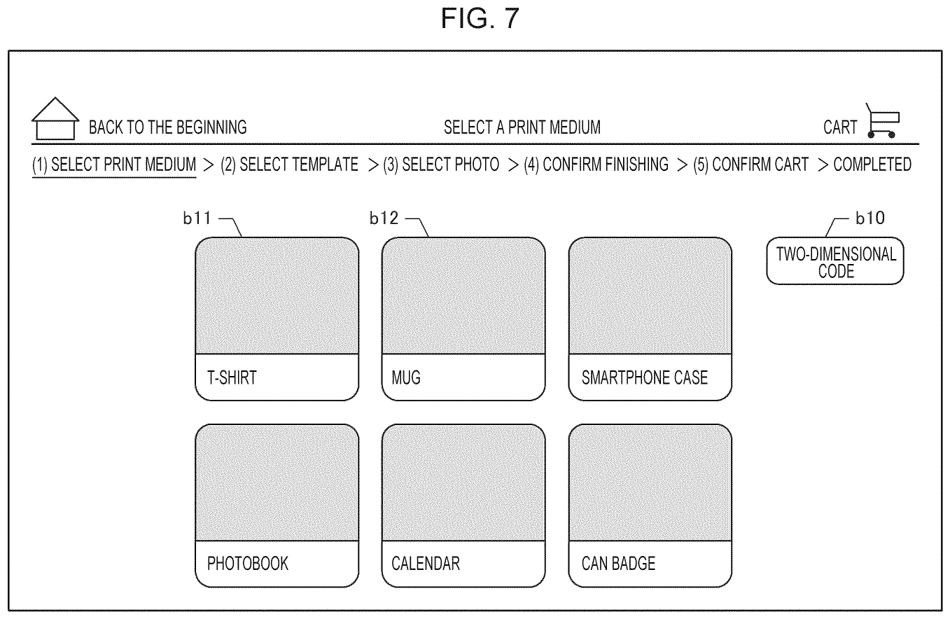

FIG. 6 is a sequence diagram showing a print sample production process. When the staff member activates the design application of the staff terminal 22, the processor 22a of the staff terminal 22 displays the print medium option. Options include, for example, a T-shirt, a mug, a photobook, and a smartphone case. FIG. 7 is a diagram showing an example of the print medium selection screen, and shows that options (b11, b12, and the like) of print medium categories such as a T-shirt and mugs are displayed. After selecting a category of print medium, such as a T-shirt, a mug, or the like, more detailed options for identifying the print medium are presented in turn. For example, in the case of the T-shirt, the options include a material, size, a color, a shape around the collar, a sleeve length, presence or absence of a breast pocket, and the like. When the staff member performs an operation to select an option indicating a print medium desired as a print sample from among these options, the processor 21a receives the selected print medium using the function of the reception unit 22a1 (step S100). That is, processor 22a acquires a set of parameters indicative of the selected options for the print medium.

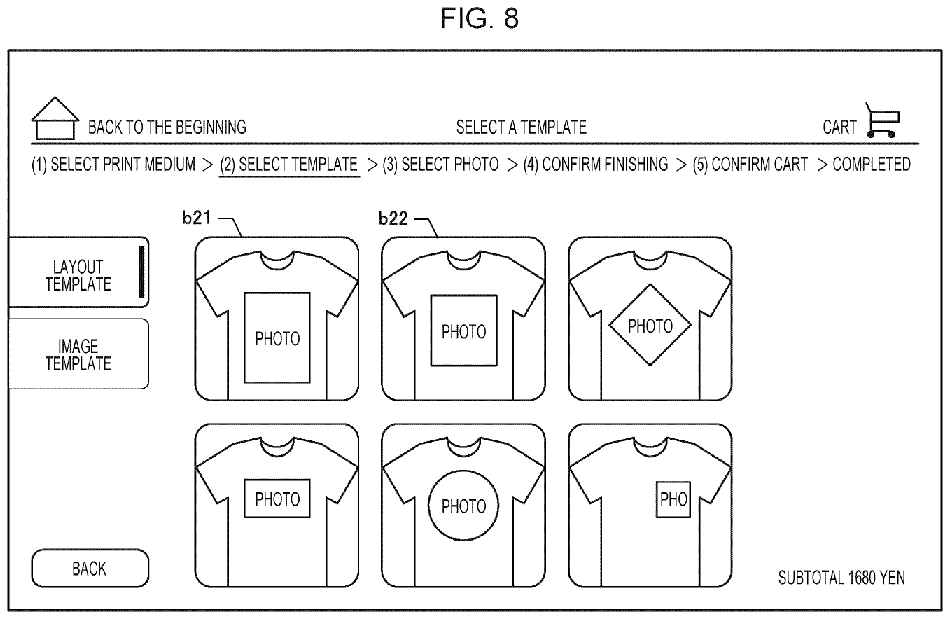

The processor 22a then displays the template options. When the staff member selects a template, the processor 22a receives the template (step S102). In the present embodiment, templates include two template types, that is, a layout template and an image template. The layout template is data that defines the position, shape, size, and the like of an area in which image data is to be disposed on a print medium, and a plurality of types of layout templates is created in advance according to the type of print medium. FIG. 8 is a diagram showing an example of the template selection screen, and shows that options (b21, b22, and the like) of layout templates are displayed.

The image template is data that defines effects to be applied to image data (for example, mosaic, monochrome, and the like), an arrangement, a font and a size when using text, an arrangement and a size when using a preset image (an icon, a stamp, a decorative character, and the like) prepared in advance on the design application, and the like, and a plurality of types image templates is prepared in advance. Any image template may be selected, and none or a plurality of image templates may be selected. Further, after selecting a template, the templates can be used as it is without fine adjustment, or can be used after fine adjustment in the editing process, which will be described later. The processor 22a acquires the set of parameters selected by the staff member for these templates.

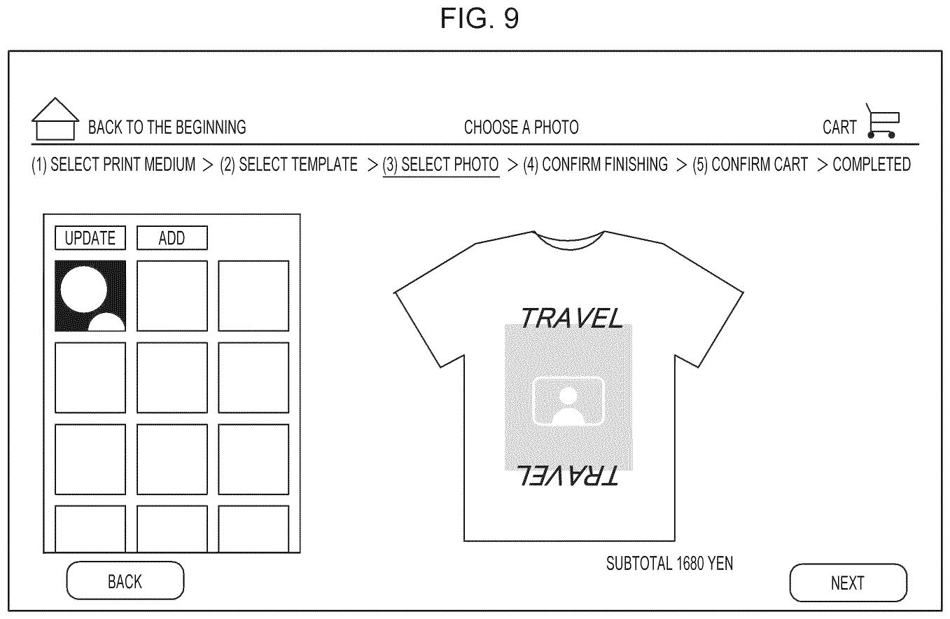

Subsequently, the processor 22a displays a screen for inputting image data for a print sample with the function of the reception unit 22a1, and acquires the sample image data input by the staff member (step S105). FIG. 9 is a diagram showing an example of a photo selection screen. The sample image data may be, for example, an image already stored in a nonvolatile memory 22c of the staff terminal 22, a free image downloaded from the Internet, or an image created or edited by the staff member. In any case, the staff member designates the sample image data, and the processor 22a acquires the image data to be used for the print sample.

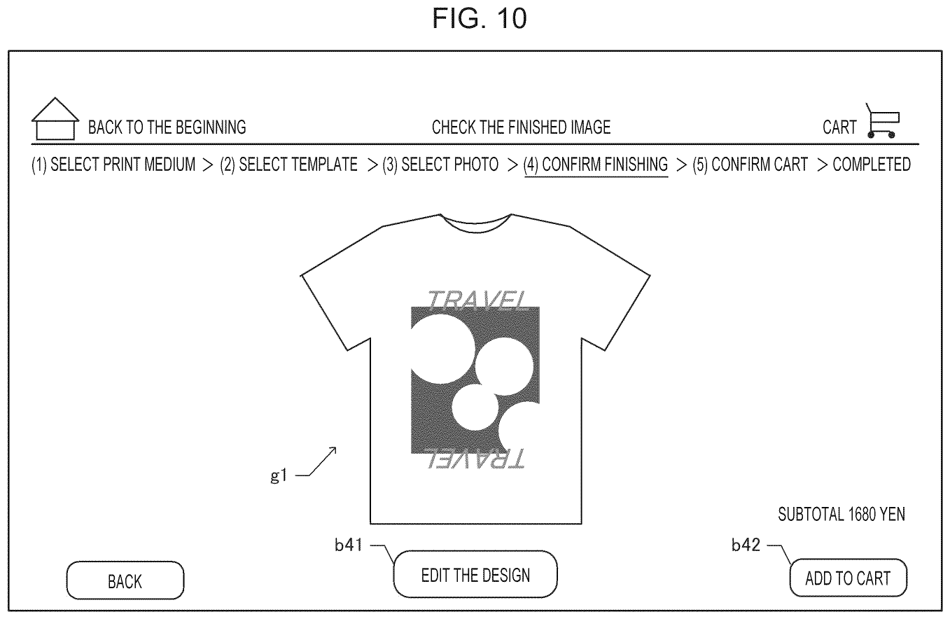

Subsequently, the processor 22a edits the sample image data according to the operation by the staff member (step S110). FIG. 10 is a diagram showing an example of the finish confirmation screen. FIG. 10 shows a print preview based on the selections made in steps S100, S102, and S105. The finish confirmation screen is provided with an edit button b41, and when the edit button b41 is selected, the processor 22a displays an edit screen (not shown). The edit screen allows the staff member to edit the design shown in the print preview. For example, the staff member can add icons and characters that the staff member wants to include in the print sample, adjust the position, the color, and the font of characters, cancel, change, or newly set effects on the entire image data to edit the design. The processor 22a acquires parameters updated as a result of editing.

Subsequently, when the staff member performs an operation to instruct printing of the edited image data using the design application, the processor 22a transmits the print job to the server 10 with the function of the production unit 22a2 and instructs printing (step S115). For example, when the staff member selects an add button b42 on the finish confirmation screen shown in FIG. 10, the processor 22a displays a cart confirmation screen (not shown). When the staff member sets and checks the number of copies, and the like on the cart confirmation screen and performs an operation to confirm execution of printing, the processor 22a transmits the confirmed print job to the server 10. That is, the print job 10c1 including the parameter indicating the type of print medium, the image data (print image) processed based on the parameter indicating the layout template, the parameter indicating the image template (if edited, the parameter after editing), or the like, the number of copies, and the like are transmitted to the server 10.

Note that when an operation to confirm the execution of printing is performed, the processor 22a generates a two-dimensional code image obtained by two-dimensionally encoding a parameter indicating the type of print medium used for the print sample and a parameter indicating the mode of a process to be performed on the sample image data (parameter indicating the layout template, parameter indicating the image template (if edited, the parameter after editing), or the like), and transmits the image together with the print job 10c1 to the server 10.

When receiving the two-dimensional code image and the print job from the staff terminal 22, the processor 10a of the server 10 stores the two-dimensional code image and the print job in association with each other in the nonvolatile memory 10c (step S120). Also, the processor 10a of the server 10 transmits a print instruction to the print job management terminal 23 (step S125). Upon receiving a print instruction for a print job from the server 10, the processor of the print job management terminal 23 selects a printer according to the type of print medium indicated by the print job, and transmits a print instruction for the print job to the print operation terminal 24 in which an application and a printer driver corresponding to the selected printer are installed (step S130).

When the print operation terminal 24 receives the print instruction, the print operator operates the print operation terminal 24 to transmit the print instruction to the printer 33 corresponding to the print job (step S135). The print operator refers to the operation schedule recorded in the server 10 and performs an operation related to printing of the print job (pre-printing process, printing process, post-printing process, and the like) according to the operation schedule. In the case of a print job that requires a pre-printing process, the print operator performs the pre-printing process, and then sets a print medium in the printer to input a print instruction to the print operation terminal 24. The print operation terminal 24 converts the image data indicated by the print job into print data in a format suitable for printing by the printer based on the print setting to transmit a print instruction together with the print data to the printer 33.

The printer 33 that has received the print instruction performs printing based on the received print data (step S140). In the case of a print job that requires the post-process, the print operator performs the post-process on the printed print medium to complete a print sample. When the printing is completed, the printer 33 notifies the server 10 via the print operation terminal 24 and the print job management terminal 23 that the printing has been completed.

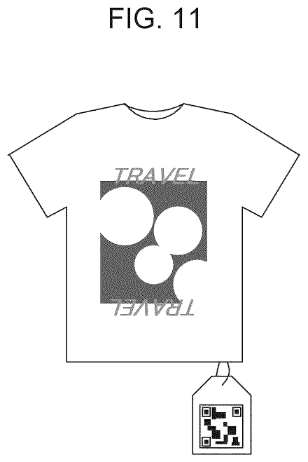

Also, the staff member operates the staff terminal 22 to instruct printing of the two-dimensional code image (step S145). That is, the staff member designates the two-dimensional code image stored in the server 10 in step S120 as a print target, downloads the image to the staff terminal 22. When the staff member instructs the document printer 32 to perform printing, for example, the processor 22a generates print data indicating the two-dimensional code image and outputs the generated data to the document printer 32 for printing. The staff member cuts out the two-dimensional code image printed on the paper, attaches the image to a cardboard tag, for example, and attaches the tag to the print sample produced in step S135 with a string or the like, thereby attaching an identifier to the print sample (see FIG. 11). The staff member displays the print sample to which the two-dimensional code image as an identifier is attached in the store. Displaying the print sample to which the identifier is attached in the store allows the user to easily place an order using the print sample, as will be described later.

### 3 Print Instruction Process

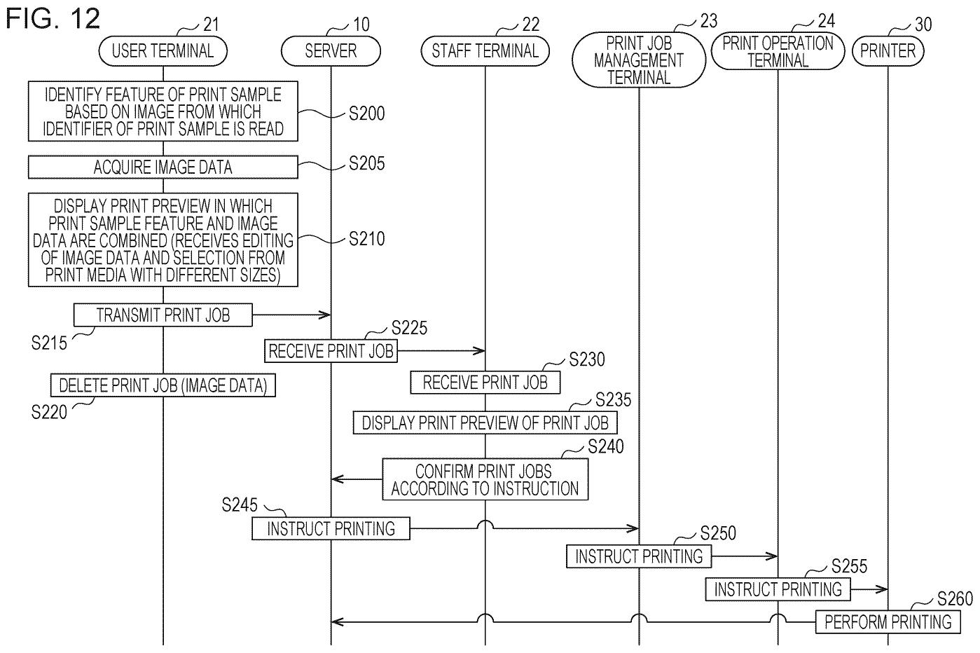

FIG. 12 is a sequence diagram showing a sequence in which a user places an order for original goods using the print sample and identifier produced as shown in FIG. 6. When the user browses the print samples displayed in the store and selects a print sample that he/she likes, the user activates the design application of the user terminal 21. In the design application, for example, the print medium selection screen shown in FIG. 7 includes a two-dimensional code read button b10. The two-dimensional code reader application is also installed in the user terminal 21. When the user selects the two-dimensional code read button b10, the processor 21a activates the camera 21f of the user terminal 21, continuously captures images, and displays a live view on the display 21d. On the live view display screen, a frame indicating the layout area within the screen of the two-dimensional code image as a subject is displayed in an overlapping manner. The user adjusts the posture of the user terminal 21 so that the two-dimensional code image attached to the print sample selected by the user appears in the frame, and causes the camera 21f to read the two-dimensional code.

The processor 21a of the user terminal 21 identifies the feature of the print sample based on the image from which the identifier is read with the function of the identifying unit 21a1 (step S200). That is, the processor 21a of the user terminal 21 executes the two-dimensional code reader application, and when the two-dimensional code image is included in the image captured by the camera 21f, converts the information indicated by the two-dimensional code into text data, for example (may be converted to non-text data). In the present embodiment, the features of the print sample are information indicating the type of print medium used for the print sample and information indicating the mode of a process performed on the sample image data.

From the text data obtained as a result of the conversion, the processor 21a identifies a parameter indicating the type of print medium used in the print sample, and a parameter indicating the mode of a process performed on sample image data (a parameter indicating the layout template, a parameter indicating the image template (if edited, a parameter after editing), and the like) as features of the print sample. The processor 21a sets these parameters indicating the feature of the print sample to the design application as being the user selected parameters for the design currently being created. Then, the processor 21a skips receiving a print medium selection operation on the print medium selection screen shown in FIG. 7, further skips receiving a template selection operation on the template selection screen shown in FIG. 8, and displays the photo selection screen shown in FIG. 9 on the display 21d.

Subsequently, the processor 21a acquires image data with the function of the acquisition unit 21a2 (step S205). When the user performs an operation to select a desired image for use in printing on the photo selection screen shown in FIG. 9, the processor 21a acquires the image data selected by the user. For example, the user may record the image data to be used for printing in his/her mobile terminal, or a cloud server, or bring the data into the store after recording it in a memory card or the like. In any case, the processor 21a acquires the image data when the user operates to transfer the image data recorded on these various recording media to the user terminal 21.

Subsequently, the processor 21a displays a print preview in which the feature of the print sample and the image data are combined with the function of the confirmation unit 21a3 (step S210). That is, the processor 21a displays the finish confirmation screen shown in FIG. 10. The finish confirmation screen includes a print preview g1. The print preview g1 is a print preview image in a case of arranging the image data designated by the user on the print medium indicated by the identifier attached to the print sample selected by the user in the manner indicated by the layout template indicated by the identifier, and performing printing by applying the image template indicated by the identifier.

Of course, the user can select the edit button b41 to make various changes to the design indicated by the print preview displayed for the first time on the edit screen (not shown). The processor 21a updates the parameter with the value after editing when editing is added. The user selects the add to cart button b42 when the editing operation is completed. The processor 21a displays a cart confirmation screen (not shown). On the cart confirmation screen, the user can input the number of copies and the like. The processor 21a acquires the input number of copies.

Further, the processor 21a can receive at least one print medium from the print medium of the print sample and a plurality of print media different in size from the print medium of the print sample in accordance with an instruction by the user with the function of the selection unit 21a5. For example, when the print medium in the added-to-cart order is M sized short-sleeved T-shirt of crew neck, no chest pocket, white, 100% cotton, it is possible to put L sized or S sized short sleeve T-shirt of crew neck, no chest pocket, white, 100% cotton in the cart, in addition to (or instead of) the M sized short-sleeved T-shirt. With this configuration, the user can easily place an order to print the same design print image created using the print sample on print medium of a different size.

When the user performs an operation to provisionally order the products in the cart, the processor 21a transmits a print job to the server 10 with the function of the printing unit 21a4 (step S215). That is, the print job 10c1 including the parameter indicating the type of print medium, the image data (print image) processed based on the parameter indicating the layout template, the parameter indicating the image template (if edited, the parameter after editing), or the like, the number of copies, and the like are transmitted to the server 10. Note that the processor 21a deletes the print job 10c1 from the user terminal 21 in response to the completion of transmission of the print job to the server 10 (step S220).

When receiving the print job from the user terminal 21 (step S225), the server 10 transmits the print job to the staff terminal 22. When receiving the print job (step S230), the processor 22a of the staff terminal 22 displays a print preview of the received print job (step S235). The staff member checks the print preview displayed on the staff terminal 22 together with the user, and performs an operation to confirm execution of printing based on the print job. The processor 22a of the staff terminal 22 confirms the print job in response to the operation to transmit the print job to the server 10 (step S240).

Also, the staff terminal 22 generates an order slip indicating the confirmed order details to transmit the generated order slip to the document printer 32 for printing. The staff member gives the order slip to the user, and the user possesses the order slip. The order slip can be used, for example, in a case where the user presents the order slip to the store staff member at the product delivery counter when receiving the product, and the staff member collates the user with the product.

Upon receiving the confirmed print job, the server 10 transmits a print instruction for the print job to the print job management terminal 23 (step S245). Upon receiving a print instruction for a print job from the server 10, the processor of the print job management terminal 23 selects a printer according to the type of print medium indicated by the print job, and transmits a print instruction for the print job to the print operation terminal 24 in which an application and a printer driver corresponding to the selected printer are installed (step S250).

When the print operation terminal 24 receives the print instruction, the print operator operates the print operation terminal 24 to transmit the print instruction to the printer 33 corresponding to the print job (step S255). In the case of a print job that requires a pre-printing process, the print operator performs the pre-printing process, and then sets a print medium in the printer 33 to input a print instruction to the print operation terminal 24. The print operation terminal 24 converts the image data indicated by the print job into print data in a format suitable for printing by the printer based on the print setting to transmit a print instruction together with the print data to the printer 33.

The printer 33 that has received the print instruction performs printing based on the received print data (step S260). When the printing is completed, the printer 33 notifies the server 10 via the print operation terminal 24 and the print job management terminal 23 that the printing has been completed. In the case of a print job that requires the post-process, the print operator performs the post-process on the printed print medium to complete the ordered product. The staff member can hand over the completed product to the user. When the product is handed over to the user, the staff member operates, for example, the staff terminal 22 to update the status of the print job with the order number indicating the product to “delivered”.

As described above, according to the present embodiment, the user can easily design and place an order for a printed matter in which the feature of the print sample and his or her own original image data are combined with little effort, compared to the case where the user designs the printed matter without using the print sample. In addition, it is possible to reduce the possibility of redoing the design due to an erroneous selection of a print medium or an erroneous setting of various parameters.

### 4 Other Embodiments

The above embodiment is an example for carrying out the present disclosure, and various other embodiments can be implemented. For example, the types of printers shown in the above embodiments are merely examples, and other printers capable of performing printing on various media may be employed. For example, for performing printing on a mug, a can badge, a smartphone case, and the like, a printer that directly performs printing on a three-dimensional object using a robot arm or the like may be employed in addition to the sublimation transfer method.

The staff terminal 22 and the user terminal 21 may be configured to directly transmit and receive information such as print jobs without going through the server 10. Also, the print job management terminal 23 and the print operation terminal 24 may be configured by one terminal, or may be omitted (the print job may be transmitted directly from the staff terminal 22 to the printer 33, or the print job may be transmitted directly from the server 10 to the printer 33).

A configuration in which a terminal and a printer are not installed at the store visited by the user may also be assumed. The terminal may be installed at the store, the printer may be installed at the printing facility of the printing company, and the printed matter may be delivered from the printing facility to the client. In addition, the terminal does not have to be installed at the store, and a configuration in which the user can place an order, edit the print image, and give the final print instruction from various places using the portable terminal may be employed.

The creation of a print sample and an identifier may be performed by any terminal. For example, a user terminal may create a print sample and an identifier outside business hours.

Moreover, the identifying unit is only required to be able to identify the print sample. The identifying unit is only required to be able to identify at least one of information indicating the print medium used for the print sample, and parameters indicating the mode of a process performed on the sample image data (parameters used for the design of the image printed as the print sample), and the like. Note that the identifier for identifying the feature of the print sample may be attached to the print sample in a printed state, or may be attached to the print sample in a state displayed on a display.

The selection unit may be configured to cause the user to select at least one print medium from the print medium of the print sample and other print media (different size, different color, different material, and the like) that have something in common with the print medium of the print sample.

In addition, in the case of a configuration in which an identifier attached to the actual print sample is read, the identifier may be represented by a barcode other than a two-dimensional code, or may be represented by numbers, letters, or symbols. Also, the identifier may be represented non-visually using an IC tag or the like. The identification unit may be configured to produce an identifier that identifies the print medium of the print sample, or may be configured to identify an element other than the print medium of the print sample. For example, the identification unit may be configured to identify a design mode.

In the above embodiment, the identifier includes the parameter group itself for identifying the feature of the print sample, but the identifier may be information for identifying the parameter group of the print sample. In this case, the print instruction system may produce the print sample and identify the print sample as follows. That is, the print instruction system may include a reception unit that receives designation of a print medium and designation of sample image data, a production unit that produces an actual print sample by performing printing on the received print medium based on the sample image data, an identification unit that produces an identifier for identifying the actual print sample, and a storage unit that stores the feature of the print sample and the identifier in association with each other. The storage unit may be any nonvolatile memory provided in the print instruction system. The identifier attached to the print sample may be a number or the like for identifying the print sample. In this case, the identification unit assigns a number for identifying the actual print sample and prints the number to produce the identifier. The storage unit stores the feature of the print sample in association with the identifier (number). Note that as a result of determining execution of printing in S115 through steps S100 to S110 in FIG. 6 of the above embodiment, the feature of the print sample is stored in the storage unit in association with the identifier. The production of the identifiers can be done before or after the production of the print samples. The produced identifier is attached to the actual print sample. The identifying unit may be configured to refer to the correspondence stored in the storage unit and identify the feature of the print sample indicated by the identifier read by the reader.

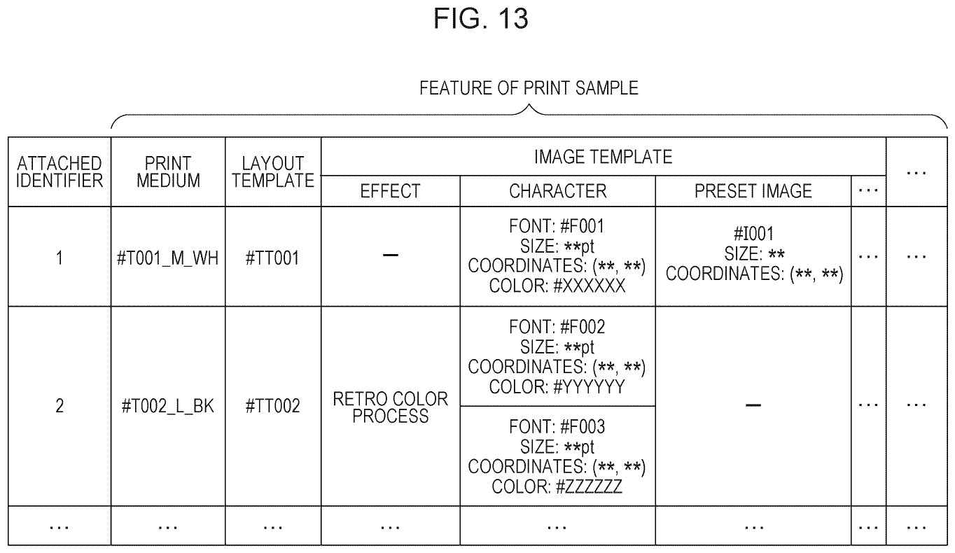

FIG. 13 is a diagram showing a configuration example of the correspondence stored in the storage unit. The print sample to which the identifier #1 is attached is a print sample produced using the information indicating the feature of the print sample associated with the identifier #1. For example, when the identifier #1 is acquired by reading the identifier with a reader, the identifying unit refers to the correspondence shown in FIG. 13 to identify the print medium used for the print sample of #1, the layout template, and information indicating modes of other various processes, so that it is possible to identify the feature of the print sample.

While, in the above-described embodiment, the identifying unit is configured to cause the reader to read the identifier attached to the actual print sample to identify the feature of the print sample, the identifying unit may be configured to cause the reader to read the actual print sample itself to identify the feature of the print sample. In this case, the print instruction system may produce the print sample and identify the print sample as follows. That is, the print instruction system may include a reception unit that receives designation of a print medium and designation of sample image data, a production unit that produces an actual print sample by performing printing on the received print medium based on the sample image data, and a storage unit that stores information for identifying the feature of the print sample. The storage unit may be any nonvolatile memory provided in the print instruction system. The storage unit stores, for example, data indicating the feature of the shape of the print medium (used for pattern matching), and data such as a training model machine-trained using a combination of an image showing the actual print sample, and features such as a category, a shape, and a color of the print medium used for the print sample. Data indicating the shape of a layout template for disposing image data on a print medium may be stored in the storage unit for pattern matching. A training model machine-trained using a combination of an image indicating the actual print sample and the shape of a layout template used for the print sample may be stored in the storage unit. Also, a configuration in which marks such as two-dimensional codes, barcodes, numbers, letters, symbols, and the like are printed on the print sample itself, and the print instruction system identifies the feature of the print sample by reading these marks may be employed. This mark may be printed at a position away from the sample image data, or may be printed together with the sample image data in a form that is not recognizable by humans using watermarks, ultraviolet ink, or the like.

The identifying unit may be configured to identify the feature of the print sample by referring to the data stored in the storage unit. For example, the identifying unit may be configured to identify the feature of the print sample by using the data and identifying the category, the shape, and the color of the print medium used for the print sample read by the reader through an image recognition process using pattern matching and a machine training model, the shape of the layout template, and the like. In addition, the identifying unit may identify the feature of the print sample by transmitting the content read by the reader to an external device such as a server, causing the external device to perform pattern matching and an image recognition process, and receiving the feature of the print sample from the external device. Note that a camera, a scanner, a 3D scanner, or the like may be employed as the reader. Alternatively, the size of the print medium may be identified based on the results of dimensional measurement of each portion of the print medium by, for example, the 3D scanner. The 3D scanner may be a handheld type or a stationary type. The confirmation unit may display the print preview in any way. For example, a print preview may be displayed using a monitor of a personal computer as a display, a print preview may be displayed using smart glasses as a display, or a print preview may be projected and displayed using a screen as a display.

Furthermore, the present disclosure is also applicable as a computer-executed program or method. The present disclosure can also be established as a disclosure of a method for producing a printed matter, the method including reading an actual print sample or an identifier attached to the actual print sample with a reader, acquiring image data, displaying a print preview when the image data and the feature of the print sample corresponding to the identifier are combined, and performing printing using the image data after displaying the print preview to produce a printed matter. The present disclosure can also be achieved as a disclosure of a print instruction program that causes a computer to function as an identifying unit, an acquisition unit, a confirmation unit, and a printing unit.

Further, the above-described system, program and method may be implemented using a single device or may be implemented using components included in a plurality of devices, and include various aspects. Further, changes may be made as appropriate, as in the case where part of the embodiment is software and part of the embodiment is hardware. Furthermore, the disclosure is established as a recording medium for a program for controlling the system. Of course, the recording medium of the program may be a magnetic recording medium, a semiconductor memory, or any recording medium to be developed in the future.

What is claimed is:

1. A print instruction system comprising:
an identifying unit that causes a reader to read an actual print sample or an identifier attached to the actual print sample;
an acquisition unit that acquires image data;
a confirmation unit that displays on a display a print preview when the image data and a feature of the print sample are combined; and
a printing unit that causes a printing mechanism to perform printing using the image data according to an instruction by a user after displaying the print preview.

2. The print instruction system according to claim 1, wherein
the feature of the print sample includes designation of a print medium used for the print sample, wherein
the system further comprises a selection unit that causes a user to select at least one print medium from among a print medium of the print sample and a plurality of print media different in size from the print medium of the print sample, and wherein
the printing unit performs printing on the selected print medium.

3. The print instruction system according to claim 1, wherein
the identifier includes a barcode or two-dimensional code.

4. The print instruction system of claim 1, further comprising:
a reception unit that receives designation of a print medium and designation of sample image data;
a production unit that produces the actual print sample by performing printing on the received print medium based on the sample image data; and
an identification unit that produces the identifier for identifying a print medium used for the print sample.

5. The print instruction system according to claim 4, wherein
the identifier includes a parameter indicating a mode of a process to be performed on the sample image data.

6. The print instruction system according to claim 1, further comprising:
a reception unit that receives designation of a print medium and designation of sample image data;
a production unit that produces the actual print sample by performing printing on the received print medium based on the sample image data; and
a storage unit that stores information for identifying a feature of the print sample, wherein
the identifying unit identifies a feature of the print sample by referring to the storage unit.

7. The print instruction system according to claim 1, further comprising:
a reception unit that receives designation of a print medium and designation of sample image data;
a production unit that produces the actual print sample by performing printing on the received print medium based on the sample image data;
an identification unit that produces the identifier for identifying the actual print sample; and
a storage unit that stores a feature of the print sample and the identifier in association with each other, wherein
the identifying unit identifies a feature of the print sample indicated by the identifier by referring to the storage unit.

8. A printing method comprising:
reading an actual print sample or an identifier attached to the actual print sample by a reader;
acquiring image data;
displaying on a display a print preview when the image data and a feature of the print sample are combined; and
performing printing using the image data after displaying the print preview.

9. A non-transitory computer-readable storage medium storing a print instruction program, the program causing a computer to function as:
an identifying unit that causes a reader to read an actual print sample or an identifier attached to the actual print sample;
an acquisition unit that acquires image data;
a confirmation unit that displays a print preview when the image data and a feature of the print sample are combined; and
a printing unit that performs printing using the image data according to an instruction by a user after displaying the print preview.
